(19) United States
(12) Patent Application Publication
(10) Pub. No.: US 2021/0158290 A1
(43) Pub. Date: May 27, 2021

(54) SYSTEM FOR DELIVERY OF A SHIPMENT AT A VEHICLE

(71) Applicant: DENSO International America, Inc., Southfield, MI (US)

(72) Inventor: Jeffrey TURK, South Lyon, MI (US)

(21) Appl. No.: 16/695,346

(22) Filed: Nov. 26, 2019

(51) Int. Cl. G06Q 10/08; G01S 19/51; G01C 21/34; H04W 4/02; H04W 4/029; H04W 4/024

(52) U.S. Cl. CPC G06Q 10/08355; G06Q 10/0833; G06Q 10/0836; H04W 4/024; G01C 21/3438; H04W 4/023; H04W 4/029; G01S 19/51

(57) ABSTRACT

A system in a vehicle includes a global positioning system (GPS) receiver configured to identify a location of the vehicle, a transceiver configured to communicate with a remote server, and a processor in communication with the GPS receiver and the transceiver. The processor is programmed to receive a signal from the remote server indicating a delivery driver is located proximate the vehicle, send a request to the remote server in response to the signal, receive a drop-off location located between the vehicle and the delivery driver in response to the request to the remote server, and output a notification at the vehicle identifying the drop-off location.

### TECHNICAL FIELD

The present disclosure relates to updating a delivery location of deliveries or other services to a vehicle.

### BACKGROUND

As online shopping becomes more popular, more consumers receive packages or deliveries at their home. However, it may be inconvenient for a delivery driver to deliver a package at an original destination when the delivery driver may be located near the package recipient. Vehicles and mobile devices may allow both the delivery driver and package recipient to share location information.

### SUMMARY

According to one embodiment, a system in a vehicle includes a global positioning system (GPS) receiver configured to identify a location of the vehicle, a transceiver configured to communicate with a remote server, and a processor in communication with the GPS receiver and the transceiver. The processor is programmed to receive a signal from the remote server indicating a delivery driver is located proximate the vehicle, send a request to the remote server in response to the signal, receive a drop-off location located between the vehicle and the delivery driver in response to the request to the remote server, and output a notification at the vehicle identifying the drop-off location.

According to one embodiment, a server includes a transceiver configured to communicate with a package recipient vehicle and a delivery driver vehicle both located remote from the server, the transceiver further configured to receive location data from both the package recipient vehicle and the delivery driver vehicle. The server also includes a processor in communication with the transceiver and programmed to determine the delivery driver vehicle is located within a threshold distance from the package recipient vehicle, send a request to both the delivery driver vehicle and the package recipient vehicle to initiate an impromptu delivery, receive acceptance from both the delivery driver vehicle and the package recipient vehicle in response to the request, and send an impromptu delivery location to both the delivery drive vehicle and the package recipient vehicle, wherein the impromptu delivery location is defined between a delivery driver location and a package recipient vehicle location.

According to one embodiment a system in a vehicle includes a global positioning system (GPS) receiver configured to identify a location of the vehicle, a transceiver configured to communicate the location of the vehicle with a remote server; and a processor in communication with the GPS receiver and the transceiver. The processor is programmed to send a request to the remote server in response to a delivery driver location within a threshold distance from the vehicle, wherein the request includes the location of the vehicle, receive a first notification indicating a first delivery option, a second delivery option, or a cancellation option to be output at a display in the vehicle, receive an input at the vehicle indicating a selection of the first delivery option, the second delivery option, or the cancellation option. The processor is further programmed to send the selection to the remote server via the transceiver and in response to selecting the first delivery option or second delivery option, receive a drop-off location from the remote server and output a second notification to the vehicle identifying the drop-off location.

### BRIEF DESCRIPTION OF THE DRAWINGS

FIG. 1 illustrates an overview of a system 100 according to one embodiment.

FIG. 2 illustrates an exemplary flowchart 200 of a vehicle preparing for an impromptu drop-off location.

FIG. 3A illustrates an example user interface 300 of a notification sent to a delivery vehicle.

FIG. 3B illustrates an example user interface 330 of a notification sent to a package recipient.

FIG. 3C illustrates an example user interface 350 of a delivery driver's acceptance to a package recipient's request.

FIG. 3D illustrates an example user interface 370 of a delivery driver declining a package recipient's request.

FIG. 4 illustrates an exemplary flowchart 400 of a server preparing an impromptu drop-off location.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Deliveries from online retailers and brick and mortar stores may be made when a delivery vehicle and a customer vehicle are near each other. However, delivery drivers and other service people may not be aware that the customer's vehicle is near the delivery vehicle, and thus have an opportunity to deliver at a destination that may be more inconvenient for both parties. There may be a need to ping the customer and arrange a drop-off location that is more convenient than the original destination. A vehicle may include various systems, sub-systems, and components that can be activated when the vehicle is aware that the delivery is imminent to allow for an impromptu delivery. This may allow a customer to receive a package quicker and more conveniently than normal. Furthermore, the delivery driver may not have to make a delivery stop later, which improves delivery times for a vendor or transit carrier. Additionally, the package may be delivered directly to the person and does not sit in an unsecured, exposed area.

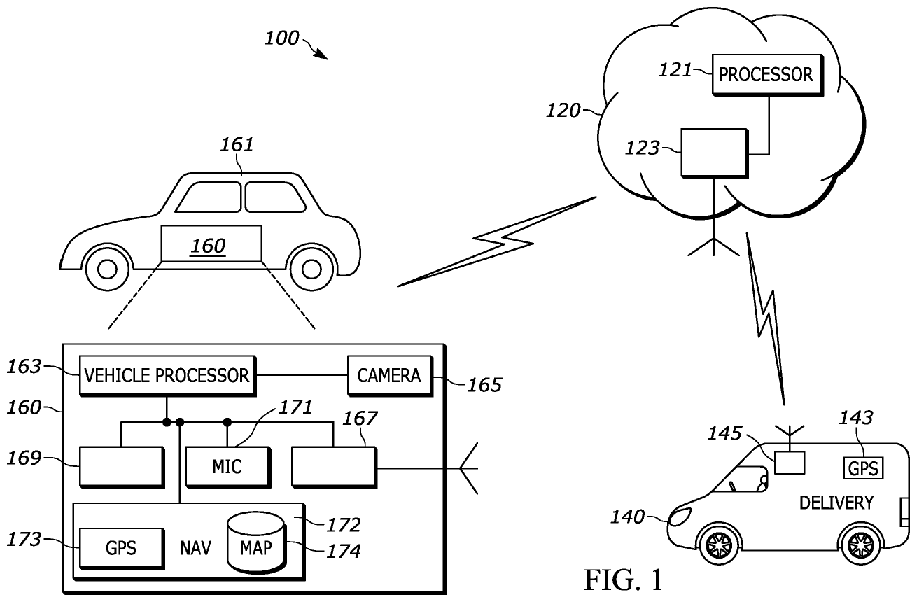

As shown in FIG. 1, a system 100 may include a remote server 120 (e.g., cloud), a delivery vehicle 140, and a vehicle 161 (e.g., customer vehicle). The vehicle 161 may include any type of vehicle, such as a passenger vehicle, a commercial vehicle, motorcycle, sport utility vehicle, minivan, sedan, watercraft, off-road vehicle, etc. The delivery vehicle 140 and vehicle 161 may be equipped with a global positioning system (GPS) receiver 143 and receiver 173, respectively. The delivery vehicle 140 may be equipped with a wireless transceiver 145. The GPS receivers 143, 173 may receive signals transmitted from satellites for the GPS. The GPS receivers 143,173 may also be in communication with a gyroscope and/or a distance sensor. The GPS receiver 143 may detect a position coordinate and an altitude of the present position of the delivery vehicle 140. The vehicle GPS receiver 173 may also detect a position coordinate and altitude of the present position of the vehicle 161. If a gyroscope is utilized, the gyroscope may output a detection signal corresponding to an angular velocity of a rotational motion applied to the delivery vehicle 140 or vehicle 161. The distance sensor may output a traveling distance of the delivery vehicle 140 or vehicle 161. In some embodiments, the delivery vehicle 140 may be equipped with a navigation controller that calculates the present position, direction, and velocity of the delivery vehicle 140 based on the output signals from the GPS receiver 143, as well as the gyroscope and the distance sensor. Further, the present position may be calculated in various methods based on the output signal from the GPS receiver 143, 173. For example, a single point positioning method or a relative positioning method may be used to calculate the present position of the delivery vehicle 140. The delivery vehicle 140 may utilize the wireless transceiver 145 to communicate with the remote server 120, which may in turn share data with a mobile device associated with the customer or vehicle 161.

The remote server 120 may include a data center controller 121. The data center controller 121 may include a microcomputer, which has a central processing unit (CPU), a read-only memory (ROM), a random access memory (RAM), an input/output (I/O) interface, and a bus line for coupling the CPU, the ROM, the RAM, and I/O interface. The data center controller 121 may include a communication device 123 (e.g., wireless transceiver, telematics device, stand-alone mobile device, or mobile device paired with a Bluetooth transceiver. The remote server 120 may communicate with the communication device 123 using any wired or wireless communication protocol, including but not limited to Long-Term Evolution (LTE), WiFi, Bluetooth, WiGig, GPS, global navigation satellite system (GNSS), near field communication (NFC), or other telecommunication protocol. In an alternate embodiment, the delivery vehicle 140 and the vehicle 161 may also communicate wirelessly according to a known communication protocol such as, for example, the Dedicated Short Range Communication (DSRC) protocol, Ultra-Wide Band (UWB) protocol, etc. The communication device 123 of the remote server 120 performs data communication with an associated mobile device of a driver of vehicle 161, the delivery vehicle 140, and the vehicle 161. The remote server 120 may be wirelessly coupled to a network via the communication device 123 to allow for data communication to various devices. The remote server 120 may include more than one data center or server.

The vehicle 161 may include a vehicle system 160 that includes a vehicle processor 163, camera 165, transceiver 167, microphone 171, and other systems or sub-systems (e.g., navigation system). The vehicle system 160 may also include a navigation apparatus. The navigation apparatus may be a portable terminal, such as a smart phone having a navigation function. The vehicle processor 163 may be utilized to send or collect data and other information from the camera 165, transceiver 167, GPS receiver 173, the microphone 171, and other vehicle components. For example, the vehicle processor 163 may be utilized to send instructions or commands to controllers associated with a vehicle compartment 169 to unlock or to provide access to the vehicle compartment 169. The transceiver 167 may be utilized to communicate with the delivery vehicle 140 and mobile device of driver of the vehicle 161 via the remote server 120 (e.g., cloud) and associated telecommunications network. The transceiver 167 may be a telematics system or mobile device paired with the vehicle system 160 via the transceiver 167 (e.g., Bluetooth transceiver or any wired or wireless transceiver). The microphone 171 may be allowed to receive spoken dialogue commands from a user in one embodiment. The microphone 171 may be configured to receive speech from the driver (e.g., the owner of the vehicle or someone who may utilize the vehicle), a delivery person or any other person. Additionally, the microphone 171 may allow a third party (e.g., a delivery person) to communicate with a remote person utilizing the microphone 171. The microphone 171 may be located in an interior cabin of the vehicle 161 (such as a passenger cabin) or may be located in an exterior location of the vehicle 161.

The vehicle system 160 may include a navigation system 172 that may be configured to generate geographic data for the vehicle 161, such as via communicating with one or more satellites orbiting Earth. The geographic data may indicate a current geographic location of the vehicle 161, such as by including current longitude and latitude coordinates of the vehicle 161. As some non-limiting examples, the navigation system 172 may include one or more of a GPS receiver, a Quazi-Zenith Satellite System (QZSS) receiver, a Russian Global Navigation Satellite System (GLONASS) receiver, a Galileo System (GSNN) receiver, an Indian Regional Navigation Satellite System (IRKS S) receiver, and an inertial navigation system (INS) receiver.

The navigation system 172 may communicate the geographic data to the vehicle processor 163, which may be configured to utilize the geographic data to determine the geographic location of the vehicle 161, and to correspondingly determine the geographic location of detected proximate objects. The vehicle 161 may also include a gyroscope or compass configured to indicate a current heading of the vehicle 161 which the vehicle processor 163 may combine with the geographic data to produce data indicating the current location and heading of the vehicle 161. Alternatively, the vehicle processor 163 may determine the heading of the vehicle 161 based on received geographic data indicating a changed position of the vehicle 161 over a short time span (e.g., one second), which suggests that the vehicle 161 is moving in a direction corresponding to the change in position.

The vehicle processor 163 may be configured to query map data 174 based on the geographic data to identify information about the travel infrastructure currently in use by the vehicle 161. In particular, the map data 174 may include detailed information about travel infrastructure in various geographic locations, such as road type (e.g., function class of the road, such as highway, city), road properties (e.g., one way, multi-lane, slope information, curvature information), detailed lane information (e.g., location, dimensions, restrictions such as no passing, turn-only, and traffic direction), and the locations and dimensions of curbs, sidewalks, traffic signals, traffic signs, and crosswalks relative to a road, as some non-limiting examples. Alternatively, the vehicle processor 163 may be configured to derive at least some of this information from proximity data generated by proximity sensors, such as via processing image data captured by camera 165 of the vehicle 161.

The vehicle system 160 may include at least one camera 165. In one embodiment, the camera 165 may be mounted in a rear-view mirror of the vehicle 161. In other embodiments, the camera 165 may be located anywhere in the vehicle cabin or outside of the vehicle 161, such as the sides of the vehicle cabin or on top of the vehicle cabin. The camera 165 may also be facing out of the vehicle cabin through a windshield of the vehicle 161 to collect imagery data of the environment in front of the vehicle 161. The camera 165 may be utilized to collect information and data regarding the front of the vehicle 161 and for monitoring the conditions ahead and/or around the vehicle 161. The camera 165 may also be used for monitoring the conditions ahead of the vehicle 161 and correctly detecting the positions of lane markers as viewed from the position of the camera 165 and the presence/absence, for example, of lighting of the head lights of oncoming vehicles. For example, the camera 165 may be utilized to generate image data related to the vehicle's surrounding, lane markings ahead, and other types of object detection (e.g., pedestrians, vehicles, cyclists, light posts, parking spots, etc.). The vehicle 161 may also be equipped with a rear camera (not shown) for similar circumstances, such as monitoring the vehicle's environment around the rear proximity of the vehicle 161. The camera 165 may be utilized to detect a delivery package being delivered to the vehicle 161 utilizing image recognition or scanning a quick response (QR) code. The camera 165 may also be utilized to detect the delivery vehicle 140 or the delivery driver, as well as other objects related to the delivery as discussed further below.

The camera 165 may also be an in-vehicle camera that may be mounted in the vehicle 161 to monitor occupants (e.g., a driver or passenger) within the vehicle cabin. The in-vehicle camera may be utilized to capture images of the vehicle cabin. For example, the in-vehicle camera may be utilized to obtain facial information from the delivery driver or the delivery package (e.g., a box). The in-vehicle camera may be a color camera, infrared camera, or time-of-flight camera. The in-vehicle camera may be mounted on a head rest, in the headliner, or located on a mobile device (e.g., tablet or mobile phone).

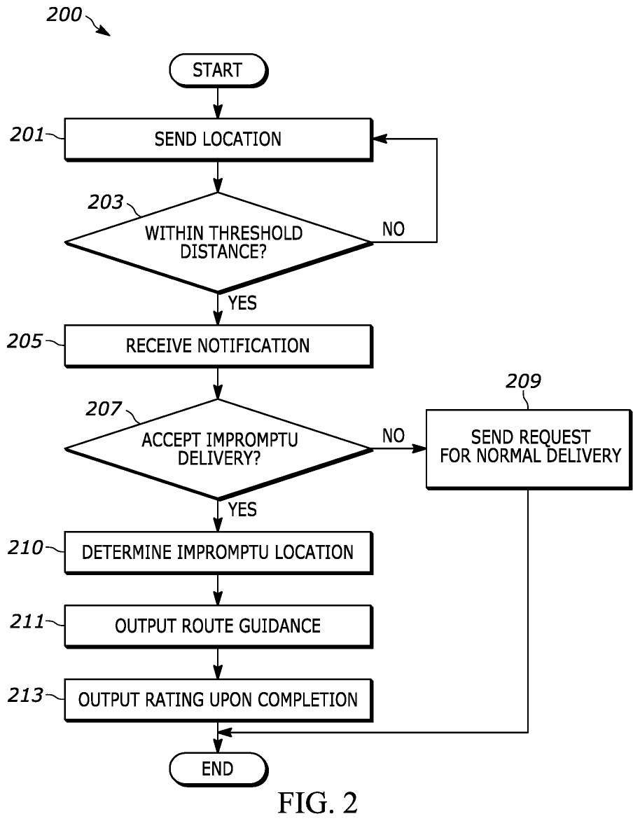

FIG. 2 illustrates an exemplary flowchart 200 of a vehicle (such as vehicle 161 described above in FIG. 1) preparing for an impromptu drop-off location. At step 201, the vehicle may send location information to the remote server. The vehicle may constantly send location information to the remote server that is utilized for tracking the vehicle. In an alternative embodiment, the vehicle may send the information when the vehicle is notified that a delivery is out for the customer of the vehicle (e.g., driver or passenger). Thus, the vehicle and remote server may be in communication to notify one another of upcoming deliveries.

The location information may be acquired from the navigation system utilizing both GPS data and/or map data, or other sensors or data. From there, the remote server may also receive location information from the delivery vehicle. The remote server may utilize information collected from the delivery vehicle as well to prepare for the impromptu delivery or drop-off location.

At decision 203, the vehicle or remote server may determine if the customer vehicle is within a threshold distance from the delivery vehicle. Any threshold distance may be utilized, such as one mile, two miles, five miles, etc. The threshold distance may be utilized as a buffer to avoid showing availability of the impromptu delivery when the location between the customer vehicle and delivery vehicle is relatively far. The threshold distance may be determined by the carrier or the user (e.g., customer). The threshold distance may vary by a manual setting that is set at the vehicle system or via an automatic default setting. The threshold distance may be a driving distance or an “as the crow flies” distance (e.g., direct distance). If the customer vehicle is not within a threshold distance of the delivery vehicle, the vehicle may constantly send location information to the server to allow monitoring of the locations of the customer vehicle and delivery vehicle. However, if the customer vehicle is within the threshold distance between the delivery vehicle, the system may prepare for the impromptu delivery.

At step 205, the customer vehicle may receive a notification that the impromptu delivery may be available as an option. The notification may be displayed on a user interface screen of the customer vehicle, such as a navigation display, multimedia display, instrument panel, etc. The notification may show an approximate distance between the customer's vehicle and the delivery vehicle. In some situations, the actual location of the delivery vehicle may be shown or may be hidden, which may help with security of the delivery vehicle. The notification may notify the customer that the package is close to the customer's vehicle. The notification may also allow the customers vehicle to ping the driver via a message or a phone call utilizing the vehicle system. The notification may provide an option to accept the impromptu delivery or to decline the impromptu delivery.

At decision 207, the system may determine whether the customer has accepted initiation of the impromptu delivery. If the customer did not accept the impromptu delivery, at step 209, the system may send a request to the delivery vehicle to proceed with normal delivery at the original residential or commercial delivery location. Thus, no further processing or collecting of data may be needed between the customer vehicle and delivery vehicle via the server.

If the customer did accept the impromptu delivery, at step 210, the system may provide various options for the location of the impromptu location. For example, one option may be to pick-up at a middle-ground location between both the customer vehicle and delivery vehicle. Another option may be to pick-up the delivery at the delivery vehicle, thus requiring no extra driving of the delivery vehicle. In yet another option, the impromptu delivery location may include a location of the customer vehicle and thus the delivery vehicle may need to drive to the customer vehicle. In another embodiment, the delivery vehicle may be able to reject the impromptu delivery if accepted by the customer. For example, the customer may accept the impromptu delivery, and the server may send a notification to the delivery vehicle informing of the acceptance. However, the delivery vehicle may reject the impromptu delivery, and the remote server may send a notification to the customer vehicle that the impromptu delivery was rejected.

The system may define where the delivery is located in terms of a type of location. For example, the system may determine to set the location at a particular point of interest or type of road. For example, the system may utilize the various geographic locations as an attribute, such as road type (e.g., function class of the road, such as highway, city), road properties (e.g., one way, multi-lane, slope information, curvature information), detailed lane information (e.g., location, dimensions, restrictions such as no passing, turn-only, and traffic direction), etc. In another example, the system may attempt to meet at a point-of-interest that includes a parking lot. Thus, the system may avoid meeting at a function class road such as a highway or freeway or other arterial roads, and prefer to meet at a main street road, collector road, or residential road. Furthermore, the system may analyze traffic density to determine a delivery location. Thus, the system may avoid meeting at a high-traffic density area (e.g., downtown New York City, etc.) and attempt to meet at a low-traffic density area to make the drop-off easier. In another scenario, the system may determine the delivery location that is on the route of either the customer vehicle or the delivery vehicle. In yet another embodiment, the system may identify the delivery location utilizing crime rate as a factor, and thus avoid high-crime areas for the delivery location.

At step 211, the system may output the route guidance. The route guidance may be output upon determining a delivery location. Thus, the navigation system of the vehicle may provide route guidance directions to the delivery location for the customer. The navigation system may also know when the vehicle has arrived at the delivery location. For example, when the customer's vehicle arrives at the delivery location. The navigation system may also be utilized to display pictures of the delivery vehicle, a delivery driver picture, pick-up rating, and arrival time.

At step 213, the customer and the delivery driver may rate the experience upon completion of the delivery. A rating system may be outputted at the customer vehicle on a display of the vehicle system that allows the customer to input a rating associated with the delivery driver. A rating system may be outputted at the delivery vehicle on a display of a delivery vehicle system that allows the delivery driver to input a rating associated with the customer. Thus, both the customer and delivery driver may have incentive to perform well during each delivery in order to have a high rating.

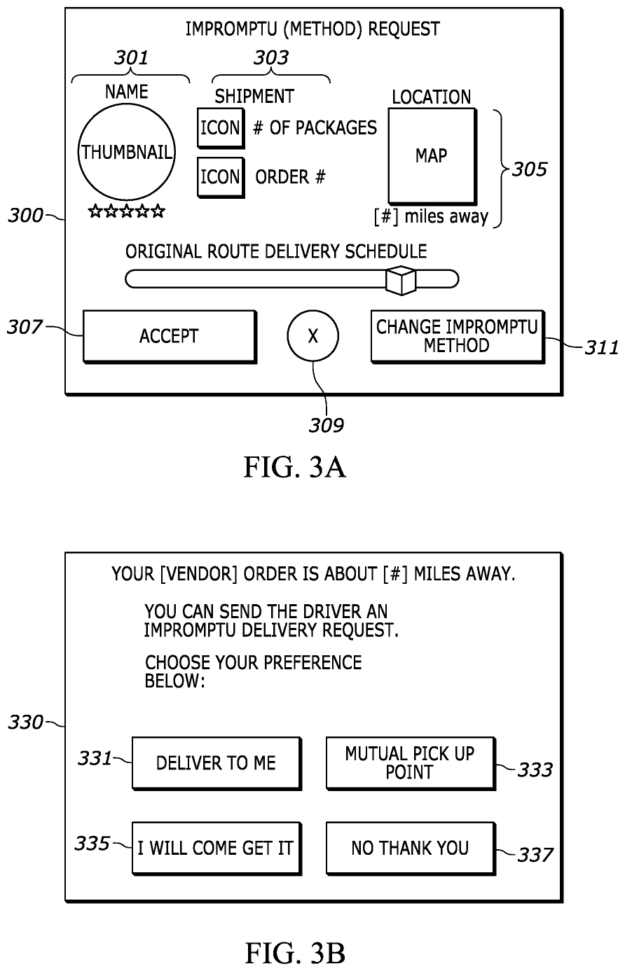

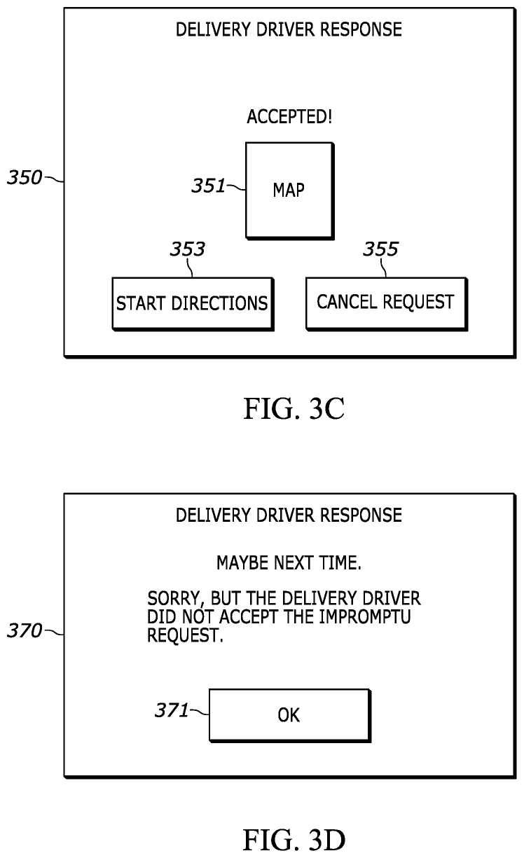

FIG. 3A illustrates an example user interface 300 of a notification sent to a delivery vehicle. The notification may be sent to the delivery driver in response to a user request to change the delivery method of the package. The user interface 300 may be displayed on any display associated with the delivery vehicle or associated equipment, such as a mobile device, tablet, mobile phone, laptop, etc. The user interface 300 may include a title or message that notifies the delivery driver of, for example, the purpose of the message. The user interface 300 may include a rating section 301. The rating section 301 may include a rating of either the delivery driver or the package recipient (e.g., the customer). The rating section 301 may include a picture and name associated with either the delivery driver or the package recipient.

The user interface 300 may also include a shipment section 303 that may identify several packages shipped and an order number. The shipment section 303 may also include pictures associated with the order that may identify what products are being delivered. In a location section 305, a map may indicate a location of the package recipient. GPS data shared with the remote server may help the delivery driver identify a location of the customer's vehicle to notify the delivery driver. The user interface 300 may also include several options associated with how to handle the delivery, including an accept option 307, cancel option 309, and a change impromptu method option 311. The change impromptu method option 311 may allow the method of delivery to be changed to either allow pickup at the delivery vehicle, customer vehicle, or a midpoint location.

FIG. 3B illustrates an example user interface 330 of a notification sent to a package recipient. The notification may be sent to the package recipient (e.g., the customer) in response to the remote server determining that the delivery driver and the customer vehicle are within the threshold distance between one another. The user interface 330 may be displayed on any display associated with the customer vehicle or associated equipment, such as a mobile device, tablet, mobile phone, laptop, etc. The user interface 330 may include a title or message that notifies the package recipient of, for example, the purpose of the message, namely that the vendor or delivery driver is a certain distance away from the vehicle. The user interface 330 may include several options to determine how to initiate an impromptu delivery request, or to cancel initiation of an impromptu delivery request. For example, an option may be available to deliver the package to the customer vehicle, or a customer location option 331. Another option may be available to deliver the package to a mutual pick-up location, or a midpoint delivery option 333. Another option may be available for the customer to pickup the package at the delivery driver's location, or a customer pickup option 335. Last, another option may allow the customer to decline the impromptu delivery, or a decline option 337.

FIG. 3C illustrates an example user interface 350 of a response of the delivery driver's acceptance to a package recipient's request. The user interface 350 of the delivery driver's acceptance may be sent to the customer vehicle or associated equipment when the carrier accepts the impromptu method, such as initiating the acceptance button on 307 on the user interface 300. The user interface 350 of the delivery driver's acceptance may include a map 351. The map 351 may provide information of the customer's current location, delivery location, traffic information, etc. The user interface 350 may include an initiation of route guidance option 353 that allows the customer's vehicle to provide route guidance to the delivery location. The user interface 350 may also include a cancel request 355 to cancel the impromptu delivery. Upon canceling the request, the delivery driver may receive a notification that the impromptu delivery was canceled.

FIG. 3D illustrates an example interface 370 of a response including the delivery driver declining a package recipient's request. The user interface 370 may be displayed on the customer vehicle or associated equipment when the delivery driver declines the impromptu method, such as in response to initiating the cancel option 309 as shown in FIG. 3A. The user interface 370 may include a confirmation button 371 to confirm that the customer received the notification.

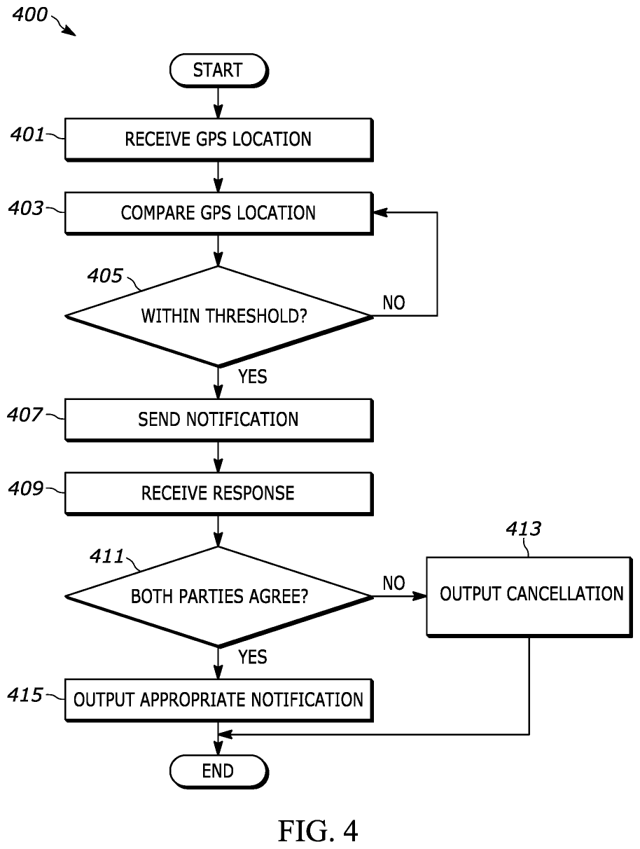

FIG. 4 illustrates an exemplary flowchart 400 of a server preparing an impromptu drop-off location. In one example, the server may be the remote server 120 discussed with respect to FIG. 1. At step 401, the server may receive both a GPS location (e.g., location data) associated with a delivery driver or delivery vehicle and a GPS location associated with the customer vehicle. The GPS location may be received from both the delivery vehicle and the customer vehicle individually. The GPS locations may be utilized to identify a location of the delivery driver or delivery vehicle to identify how close they are to the customer vehicle. The GPS locations may be associated with a navigation system or telematics unit of the delivery vehicle and customer vehicle, or a mobile device associated with the delivery driver or customer vehicle. The server may send the GPS location associated with the customer vehicle owner (e.g., customer vehicle location or mobile device location) to the delivery driver (e.g., via application or SMS message to a mobile device, tablet, computer, etc.). The GPS location associated with the delivery driver and customer vehicle may be pinged and transmitted automatically to the server at a reoccurring interval (e.g., every second, every five seconds, every minute, etc.), or by a request from the customer vehicle owner. In another embodiment, the server may also receive routing information for both the customer vehicle and the delivery vehicle. Thus, the routing information may be utilized to determine an impromptu delivery location that is reflective of a future area that both the delivery driver and the customer vehicle may be headed towards.

At step 403, the server may compare the GPS location associated with the customer vehicle and the delivery vehicle. The server may determine a distance between both locations of the customer vehicle and the delivery vehicle. The distance may be calculated utilizing a driving distance or an “as the crow flies” distance (e.g., direct distance). If the server calculates the distance utilizing the driving distance, the GPS location associated with the delivery vehicle and the customer vehicle may be plotted on map at the server. From there, the server may determine the distance between both locations utilizing a driving distance calculation. The server may also factor in traffic data to determine how far an estimated time of an arrival is for the customer vehicle and the delivery vehicle to meet. In another example, the server may calculate routing information to determine a location that the delivery vehicle and the customer vehicle are headed. Thus, the server may be able to determine if it is appropriate to evaluate a future delivery versus an imminent delivery.

At decision 405, the server may determine whether the GPS location between the delivery vehicle and the customer vehicle is located within a threshold distance to initiate an opportunity for an impromptu delivery. Any type of threshold distance may be utilized. The threshold distance may be determined by, for example, the carrier, the user, or the server. Thus, the threshold distance may be adjusted by a manual setting. The threshold distance may be a driving distance or an “as the crow flies” distance (e.g., direct distance). When the two locations are not within the threshold distance, the system may simply continue to compare the locations of the delivery driver and the customer vehicle. Thus, the server may continuously receive GPS location data from both the delivery vehicle and customer vehicle and compare the two GPS locations until the threshold is met. For example, if the delivery vehicle and customer vehicle are nine miles apart and the threshold distance is five miles, the system may continuously monitor both locations. However, if the two locations are within the threshold distance, the system may attempt the impromptu delivery. In an alternative embodiment, the threshold distance may instead utilize a threshold driving time that factors traffic data to determine a driving time between the customer vehicle and the delivery vehicle. Thus, in a high-traffic area such as New York City, the threshold driving time may be utilized to determine whether to send a notification for an impromptu delivery.

At step 407, the server may send information to allow the delivery vehicle and customer vehicle to output the appropriate notification associated with the impromptu delivery. For example, the notification may allow the customer vehicle and the delivery vehicle to display the notifications as shown in FIGS. 3A-3B. The server may send the relevant data to the customer vehicle and the relevant data to the delivery vehicle. For example, the data may be data indicative of a successful execution of an impromptu delivery, or the data may be indicative of an unsuccessful execution (e.g., cancellation) of an impromptu delivery (e.g., one party declines to initiate the impromptu delivery). The data sent from the server may be utilized to allow the vehicle system (e.g., customer vehicle or delivery vehicle) to identify the appropriate notification to display to the user (e.g., customer vehicle or associated mobile device) or carrier (e.g., delivery vehicle). In an alternative embodiment, the remote server may generate the actual interface and message to be sent to the customer vehicle and delivery vehicle. Thus, the server may generate the interface and notifications shown in the FIGS. 3A-3B, for example.

At step 409, the server may receive the response (e.g., selection) from both the customer vehicle and the delivery vehicle associated with the impromptu delivery. Data indicating the response is sent from the customer vehicle and the delivery vehicle to the server. Thus, the server may receive the data from the customer vehicle and delivery vehicle that are generated based on the feedback or input from the interfaces of FIGS. 3A-3B, such as whether the customer or delivery driver accepted or declined the impromptu delivery, or suggested a preferred impromptu delivery method (e.g., deliver to the customer, meet at a mutual point, customer drivers to the delivery vehicle, etc.). The server may receive both responses and compare each response to see if the parties agree to the impromptu delivery. For example, the server may receive a response sent from the customer vehicle indicating whether it wishes to initiate the impromptu delivery and the server may receive a separate response sent from the delivery vehicle indicating whether it wishes to initiate the impromptu delivery.

At decision 411, the server may determine whether both parties agree to the impromptu delivery in view of the comparison. The server may also determine the appropriate impromptu method of delivery, as discussed above. For example, the server may receive a response from the delivery vehicle that it would proceed with an impromptu delivery, but the customer vehicle sends a cancellation request to the server. In such a scenario, the server would not proceed with an impromptu delivery, given that both parties did not accept the delivery. In another example, the server may receive a response from the customer vehicle that it would proceed with an impromptu delivery, but the delivery vehicle sends a cancellation request to the server. In such a scenario, the server would not proceed with an impromptu delivery, given that both parties did not accept the delivery. In yet another example, the server may receive a response from both the customer vehicle and the delivery vehicle that it would proceed with an impromptu delivery. In such a scenario, the server would proceed with an impromptu delivery because both parties accepted the impromptu delivery request. In an alternative embodiment, the server may only need to receive an acceptance from the customer vehicle to initiate an impromptu delivery. Thus, in this alternative embodiment, the system may also only send a notification to the customer vehicle that indicates whether or not to initiate an impromptu delivery.

At step 413, if both parties do not agree to the impromptu delivery (as described above), the server may output a cancellation notification to both the delivery vehicle and the customer vehicle. For example, the cancellation notice may include the embodiment described in FIG. 3D. The server may send the response or other data indicating that the delivery driver did not accept the impromptu delivery. The server may send the relevant data to the customer vehicle and the delivery vehicle to output the appropriate cancellation notification to display. In addition, the cancellation notification may also be sent to another non-vehicle user interface associated with the customer, carrier, or associated mobile device.

At step 415, if both parties agree to the impromptu delivery, the server may output an appropriate notification to both the delivery vehicle and the customer vehicle that an impromptu delivery has been successfully initiated. For example, the notification may include the one shown in FIG. 3C. Of course, other embodiments may show different information on the notification screen. For example, one embodiment may include a notification indicating a real-time map of locations for both the delivery vehicle and the customer vehicle. The server may send the notification or other data indicating that the delivery driver accepted the impromptu delivery. The server may send confirmation to both the delivery driver and the customer vehicle. The server may send the relevant data to the customer vehicle and the delivery vehicle to identify the appropriate notification to display. In addition, the notification that the impromptu delivery has been initiated may be sent to another user interface associated with the customer, carrier, or associated mobile device. In the alternative, as the delivery vehicle and the customer vehicle drive closer to one another, the server may send estimated time of arrival information to both the delivery vehicle and the customer vehicle. In an alternative embodiment, the remote server may generate the actual interface and message to be sent to the customer vehicle and delivery vehicle. Thus, the server may generate the interface and notifications shown in the FIGS. 3C-3D, for example.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system in a vehicle, comprising:
a global positioning system (GPS) receiver configured to identify a location of the vehicle;
a transceiver configured to communicate with a remote server; and
a processor in communication with the GPS receiver and the transceiver and programmed to:
receive a signal from the remote server indicating a delivery driver is located proximate the vehicle;
send a request to the remote server in response to the signal;
receive a drop-off location located between the vehicle and the delivery driver in response to the request to the remote server; and
output a notification at the vehicle identifying the drop-off location.

2. The system of claim 1, wherein the signal from the remote server identifies that the delivery driver is within a threshold distance from the vehicle.

3. The system of claim 1, wherein the notification includes an option to start route guidance to the drop-off location.

4. The system of claim 1, wherein the drop-off location is identified to be located at a road that is not a freeway or a highway.

5. The system of claim 1, wherein the drop-off location is identified in response to a traffic density at the drop-off location.

6. The system of claim 1, wherein the drop-off location is identified as a point-of-interest that includes a parking lot.

7. The system of claim 1, wherein the drop-off location is identified in response to a safety factor at the drop-off location.

8. The system of claim 1, the drop-off location is identified in response to a function class of a road at the drop-off location.

9. A server, comprising:
a transceiver configured to communicate with a package recipient vehicle and a delivery driver vehicle both located remote from the server, the transceiver further configured to receive location data from both the package recipient vehicle and the delivery driver vehicle, and
a processor in communication with the transceiver and programmed to:
determine the delivery driver vehicle is located within a threshold distance from the package recipient vehicle;
send a request to both the delivery driver vehicle and the package recipient vehicle to initiate an impromptu delivery;
receive acceptance from both the delivery driver vehicle and the package recipient vehicle in response to the request; and
send an impromptu delivery location to both the delivery driver vehicle and the package recipient vehicle, wherein the impromptu delivery location is defined between a delivery driver location and a package recipient vehicle location.

10. The server of claim 9, wherein the impromptu delivery location is a midway point between the delivery driver location and package recipient vehicle location.

11. The server of claim 9, wherein the impromptu delivery location is at the package recipient vehicle location.

12. The server of claim 9, wherein the impromptu delivery location is defined on a residential or arterial function class of a road.

13. The server of claim 9, wherein the impromptu delivery location is defined as a point of interest including a parking lot.

14. A system in a vehicle, comprising:
a global positioning system (GPS) receiver configured to identify a location of the vehicle;
a transceiver configured to communicate the location of the vehicle with a remote server; and
a processor in communication with the GPS receiver and the transceiver, the processor programmed to:
send a request to the remote server in response to a delivery driver location within a threshold distance from the location of the vehicle, wherein the request includes the location of the vehicle;
receive a first notification indicating a first delivery option, a second delivery option, and a cancellation option to be output at a display in the vehicle;
receive an input at the vehicle indicating a selection of the first delivery option, the second delivery option, or the cancellation option;
send the selection to the remote server via the transceiver; and
in response to selecting the first delivery option or second delivery option, receive a drop-off location from the remote server and output a second notification at the display identifying the drop-off location as associated with an impromptu delivery.

15. The system of claim 14, wherein the first delivery option is associated with the delivery driver location.

16. The system of claim 14, wherein the second delivery option is associated with the location of the vehicle.

17. The system of claim 14, wherein the processor is programmed to provide route guidance to the drop-off location.

18. The system of claim 14, wherein the first notification includes a third delivery option, wherein the third delivery option includes a mutual pick-up location.

19. The system of claim 14, wherein the processor is further programmed to, in response to selecting the cancellation option, receive from the remote server data indicating cancellation of the impromptu delivery, and output a third notification displaying cancellation of the impromptu delivery.

20. The system of claim 14, wherein the drop-off location is identified in response to traffic flow at the drop-off location.
